(19) United States
(12) Patent Application Publication
(10) Pub. No.: US 2003/0126213 A1
(43) Pub. Date: Jul. 3, 2003

(54) Establishing direct instant messaging communication between wireless devices

(75) Inventor: Boas Betzler, Wappingers Falls, NY (US)

Correspondence Address: Kevin P. Radigan, Esq., Heslin Rothenberg Farley & Mesiti P.C., 5 Columbia Circle, Albany, NY, 12203, US

(73) Assignee: International Business Machines Corporation, Armonk, NY

(21) Appl. No.: 10/039,061

(22) Filed: Jan. 2, 2002

(51) Int. Cl. G06F 15/16

(52) U.S. Cl. 709/206

(57) ABSTRACT

Techniques are provided for establishing direct instant messaging communication between wireless devices. An instant messaging (IM) session is initiated on a client/server paradigm and responsive to identifying at least one additional wireless device belonging to a same piconet, the IM session is transformed into a peer-to-peer communication by establishing a direct instant messaging connection between wireless devices.

### FIELD OF THE INVENTION

The present invention relates in general to messaging techniques, and more particularly, to techniques for establishing peer-to-peer instant messaging communications between wireless devices.

### BACKGROUND OF THE INVENTION

The Internet and many on-line information services provide electronic mail, conferencing and chat services, and an ability to access remote computers for sending and retrieving files. Electronic mail, perhaps the most widely used of Internet and on-line service applications, has an inherent asynchronous or “off-line” time delay characteristic.

Instant messaging, or simply chat, provides informal communications among users of data network facilities. Instant messaging allows two or more users to converse by exchanging (for example) text messages, typically through a channel or a virtual chat room maintained on one or more instant messaging servers, and conventionally accessed via an on-line service or using general purpose client software executing at a user terminal, workstation or personal computer. Only chat participants connected, for example, through a telephone line modem, to the on-line service or other chat environment provided by one or more chat servers can take part in an instant messaging session.

Instant messaging (IM) allows a user to launch a message to another user. Variants of IM permit a notice to be sent to others, e.g., located on a buddy list, when a particular user logs onto a server, even without joining a chat or other multi-person conversation. Users announce their availability to receive messages by electing options or submitting system parameters in advance. The sender of an instant message determines who will receive the message.

Instant messaging allows users to exchange information synchronously. Examples of Internet based instant messaging are Internet Relay Chat (IRC), America Online Instant Messenger, Yahoo Messenger, VPBuddy, Sametime and Jabber. All these technologies are client/server based, with the users typically employing personal computers connected to the internet to use the instant messaging system.

More and more pervasive devices are being used to connect to the Internet. Examples are Internet Appliance devices, ThinClients, Handhelds and cellular phones. Wireless communication connects these devices to the Internet, however, the same concept for instant messaging is applied; that is, the instant messaging remains client/server based.

Thus, a drawback to existing instant messaging services is their continual reliance on the presence of an instant messaging server or server directory to facilitate the IM communication between clients, even when the clients comprise wireless devices. A need therefore exists in the art for an instant messaging technique for wireless devices which allows dependence on server based communications to be reduced.

### SUMMARY OF THE INVENTION

The shortcomings of the prior art are overcome and additional advantages are provided through the provision of a method of establishing instant messaging communication between wireless devices. The method includes: employing an instant messaging server to identify for a first wireless device at least one additional wireless device belonging to a same piconet as the first wireless device; and establishing direct instant messaging communication between the first wireless device and a second wireless device, wherein the second wireless device is one device of the at least one additional wireless device belonging to the same piconet, and wherein the direct instant messaging communication between the first wireless device and the second wireless device comprises direct wireless communication therebetween.

In another aspect, an instant messaging method is provided which includes: establishing connection of a first wireless client to an instant messaging server; sending a request from the first wireless client to the instant messaging server for identification of available wireless clients for instant messaging; receiving available wireless client information at the first wireless client from the instant messaging server; and establishing direct wireless connection between the first wireless client and a second wireless client using the available wireless client information received from the instant messaging server, wherein the direct wireless connection allows direct wireless communication between the first wireless client and the second wireless client.

Systems and computer program products corresponding to the above-summarized methods are also described and claimed herein.

To restate, provided herein are techniques for establishing direct instant messaging communication between wireless devices. In accordance with the present invention, an instant messaging (IM) session is transferred from a client/server model to a peer-to-peer communication model once information is exchanged that some or all IM session participants are part of a same wireless network, such as a piconet. Advantageously, by transitioning the IM session to direct peer-to-peer communication, less server resources are employed. Once the peer-to-peer IM session communication is established, no further communication to the server is needed for participants to communicate. Thus, messages between the participants no longer need to be stored and forwarded through an IM server. This frees up the server allows messages to pass directly over an established radio frequency link, thereby saving server and network resources. In addition, there is a lower message transmission latency between participants of the IM session. Should the server's network go down, the participants can still communicate within the IM session. Also, once the peer-to-peer IM session is established, better security is provided through the limited message distribution through the wireless network, such as a piconet.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be apparent from the following detailed description taken in conjunction with the accompanying drawings in which:

FIG. 1 depicts one embodiment of a messaging environment wherein a first wireless client seeks to establish instant messaging communication with a second wireless client in accordance with an aspect of the present invention;

FIG. 2 depicts the messaging environment of FIG. 1 after direct instant messaging communication has been established between wireless client1 and wireless client2 in accordance with an aspect of the present invention;

FIG. 3 depicts one flowchart embodiment of processing for establishing direct instant messaging communication between wireless clients in accordance with an aspect of the present invention; and

FIG. 4 depicts one embodiment of message transfer between a client1, a client2, and an instant messaging server when establishing direct instant messaging communication in accordance with an aspect of the present invention.

### BEST MODE FOR CARRYING OUT THE INVENTION

Generally stated, provided herein is a technique for initiating an instant messaging (IM) session on a client/server paradigm and transforming the IM session into a peer-to-peer communication once information is exchanged that some or all chat participants are part of a same wireless network. Before describing certain embodiments of the technique in accordance with aspects of the present invention, various terms are defined:

Peer-to-Peer: Peer-to-peer is a communications model in which each party has similar capabilities and either party can initiate a communication session. Other models with which it might be contrasted include a client/server model and a master/slave model. In certain cases, peer-to-peer communications is implemented by giving each communication node both server and client capabilities. In recent usage, peer-to-peer has come to describe applications in which users can use the Internet to exchange files with each other directly or through a mediating server. However, in the context of the present invention, peer-to-peer is used to describe applications in which users can communicate with each other directly, without using a mediating server such as an IM server wired to a network.

Client/Server: Client/server describes the relationship between two computer programs in which one program, the client, makes a service request from another program, the server, which fulfills the request. Although the client/server idea can be used by programs within a single computer, it is more often used in a network. In a network, the client/server model provides a convenient way to interconnect programs that are distributed across different locations. Computer transactions using the client server model are very common. For example, to check a bank account from a personal computer, a client program in the computer forwards a request to a server program at the bank. That program may in turn forward the request to its own client program that sends a request to a database server at another bank computer to retrieve the account balance. The balance is returned back to the bank data client, which in turn serves it back to the client in the personal computer, which displays the information for the individual. The client/server model has become one of the central ideas of network computing. Most business applications written today use the client/server model. So does the Internet's main program TCP/IP. In marketing, the term has been used to distinguish distributed computing by smaller dispersed computers from the “monolithic” centralized computing of mainframe computers. But this distinction has largely disappeared as mainframes and their applications have also turned to the client/server model and become part of network computing.

In the usual client/server model, one server, sometimes called a daemon, is activated and awaits client requests. Typically, multiple client programs share the services of a common server program. Both client programs and server programs are often part of a larger program or application. Relative to the Internet, a Web browser is a client program that requests services, e.g., the sending of Web pages or files, from a Web server in another computer somewhere on the Internet. The Web server technically is called a Hypertext Transport Protocol or HTTP server. Similarly, a computer with TCP/IP installed allows a user to make client requests for files from File Transfer Protocol (FTP) servers in other computers on the Internet.

Other program relationship models include master/slave, with one program being in charge of all other programs, and peer-to-peer, with either of two programs able to initiate a transaction.

Piconet: A network of devices connected in an ad hoc fashion using direct connection wireless technology, such as Bluetooth technology. A piconet is formed when at least two devices, such as a portable PC and a cellular phone, connect. A Bluetooth-based piconet can today support up to eight devices. When a piconet is formed, one device acts as a master while the others act as slaves for the duration of the piconet connection. A piconet is sometimes called a PAN (i.e., Pico Area Network). “Piconet” is a combination of the prefix “pico”, meaning very small or one trillionth, and network. Broadly stated, a piconet is used herein to mean any wireless network with direct peer-to-peer capabilities. Typically, a piconet has a range characteristic and a frequency or bandwidth characteristic. The range refers to the distance with which, for example, the radio frequency signals may carry (with 300 feet being an example today), while frequency or bandwidth refers to the frequency at which users are communicating using their wireless devices. Further, a piconet can be established between the same type of wireless devices or different types of wireless devices.

Bluetooth Technology: The Bluetooth standard is an open wireless communication technology that forms small piconets. The Bluetooth standard is described in a publication by Brent A. Miller and Chatschik Bisdikian entitled “Bluetooth Revealed”, published by Prentice Hall, ISBN: 013090294-2 (2001), which is hereby incorporated herein by reference in its entirety.

Jabber: Jabber is an open instant messaging program or protocol described, for example, by D. J. Adams in a publication entitled “Programming Jabber”, published by O'Reilly & Associates, ISBN 0596002025 (2001); and in an article by Doc Searls entitled, “The Next Bang: The Explosive Combination of Embedded Linux, XML and Instant Messaging” Linux Journal, No. 77 (September 2000), both of which are hereby incorporated herein by reference in their entirety.

Briefly described, with Jabber every user interacts through a local server that transfers messages to and through any number of other servers, each with its own domain. Jabber identifiers are also expressed like email: yourname@domain.com. Clients and servers converse among themselves through XML streams. In client/server conversations, the XML stream is always initiated by the client to the server. The architecture can support simple clients (e.g., a direct telnet connection) as well as AIM, ICQ and other proprietary clients. Since it is built on XML, Jabber is extensible and able to express just about any kind of structured data. Jabber's own protocol consists of XML fragments passed over XML streams between clients and servers. There are three primary protocols that define the basic types of XML fragments used in Jabber: Messages, Presence and Info/Query. Server-to-server communication involves routing these protocol elements over an XML stream from one server to another (there are no special server-to-server protocols or features). A Module API lets the server use external modules to handle message filtering, storage facilities (off-line messages, rosters, user info), user authentication and other functions. A Service API allows integration of security, special connections for alternate clients and message logging. Transport servers are used to bridge the Jabber protocol to other services, such as IRC, ICQ and AIM.

Instant Messaging: Instant messaging (IM) is a mode of communication which allows users to exchange information substantially synchronously. As noted initially, examples of internet-based instant messaging are Internet Relay Chat (IRC), America Online Instant Messenger, Yahoo Messenger, VPBuddy, Sametime and Jabber. As a further detailed example, IRC protocol is discussed in an article by J. Oikarinen and D. Reed entitled: “Internet Relay Chat Protocol”, IETF (May, 1993).

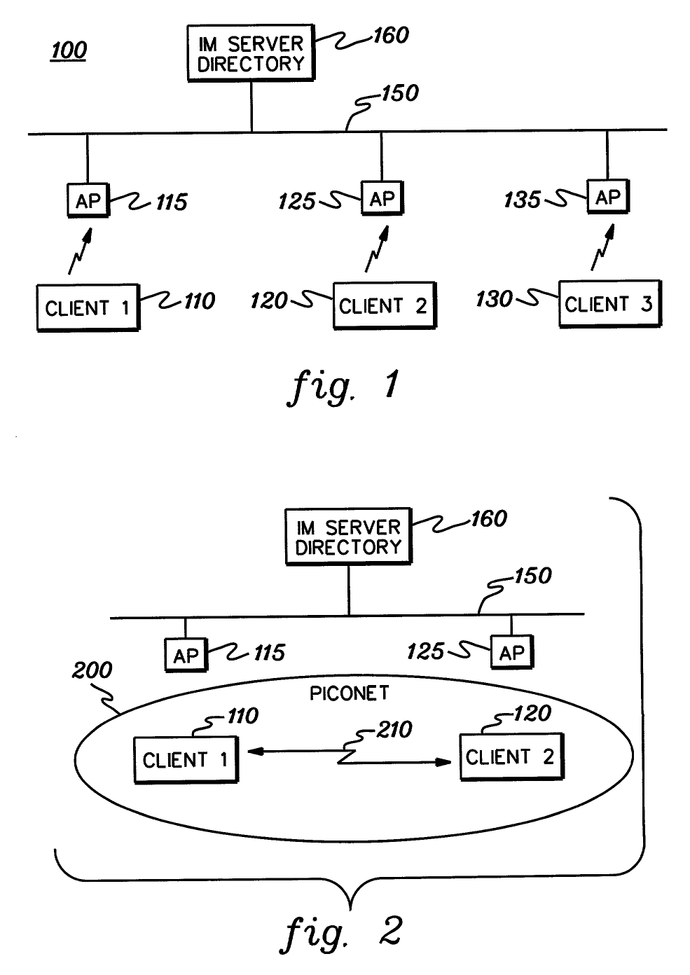

FIG. 1 depicts one embodiment of a messaging environment, generally denoted 100, wherein a wireless client, for example, client1 110, seeks to establish an instant messaging session with a second and/or third wireless client, for example, client2 120 and/or client3 130. Conventionally, client1 communicates through an access point 115 to a wired network 150 having an instant messaging (IM) server directory 160 connected thereto. Similarly, client2 120 communicates through AP 125 with wired network 150, while client3 communicates in this example through an AP 135 with wired network 150. In another embodiment, multiple clients could communicate through a same AP with the IM server directory of the wired network. Also, note that as used herein, a client can refer to an identity of a wireless device or identity of a wireless device plus a user thereof, depending upon whether the wireless devices are shared among users or are each proprietary to a particular user. The concepts of the present invention can be employed with either configuration.

FIG. 2 depicts an object of the present invention, that is, the establishing of a direct wireless IM communication 210 between wireless devices such as client1 110 and client2 120 belonging to a same piconet 200. Examples for accomplishing this direct wireless IM connection are described below using the Bluetooth wireless communication standard as an example and XML based instant messaging (i.e., Jabber protocol).

As a conventional IM example, client1 and client2 would connect to an IM server and start a chat. The chat at this point includes only those two clients and all transactions are sent to the server which then forwards the transactions to the clients. The communications thus have the server in the middle:

client1----(to client2, “How are you”)---->server------(from client1, “How are you”)---->client2

client1<----(from client2, “Good”)------server<------(to client1, “Good”)----client2

In accordance with an aspect of the present invention, two or more clients might exchange their metadata, which in one example would be their respective Bluetooth Device Address (BD_ADDR) and Access Code (CAC,DAC)information. This data identifies a piconet that each client is a member of. The clients can then check to see if they are part of the same piconet, and if so, the clients can continue the IM communication in a direct, peer-to-peer mode, with the IM server no longer being used.

client1—---(to client2, “Now we are peers”)--->client2

client1<---------------(from client2, “Yes”)-----client2

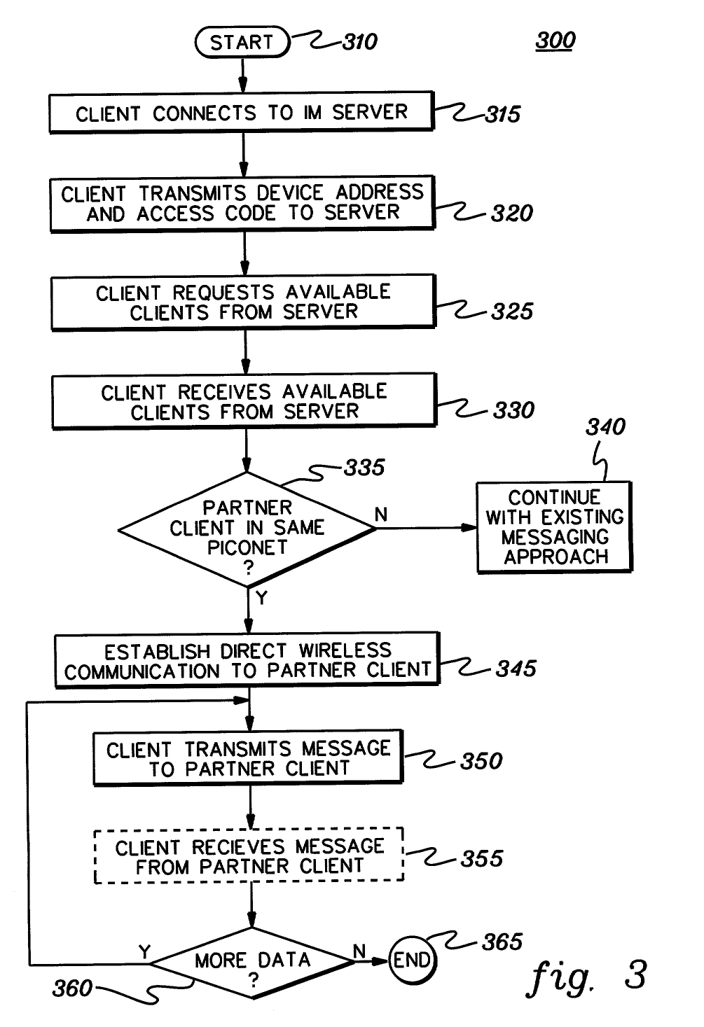

FIG. 3 depicts one example of processing implemented in accordance with an aspect of the present invention. This processing, generally denoted 300, allows a client to query an instant messaging server for device address and access code information on one or more partner clients in a same piconet, thereby allowing the client to establish direct wireless instant messaging communication with the partner client(s). Processing begins 310 with the client connecting to an IM server 315. The client then transmits its own device address and access code information to the server 320 and requests that the server provide information on available clients 325. The client receives the available client information from the server 330 and parses the information to determined whether a partner client is in a same piconet 335. If not, then the existing client/server based instant messaging approach can be employed for communications between the clients 340.

Assuming that the partner client is in the same piconet, then the client establishes direct wireless communication to the partner client 345 and begins to transmit a message to the partner client 350. The partner client may itself communicate a message back to the client 355. This instant messaging communication continues as long as data 360 continues to be generated for sending. Once the instant messaging session is complete, the wireless peer-to-peer connection is terminated 365.

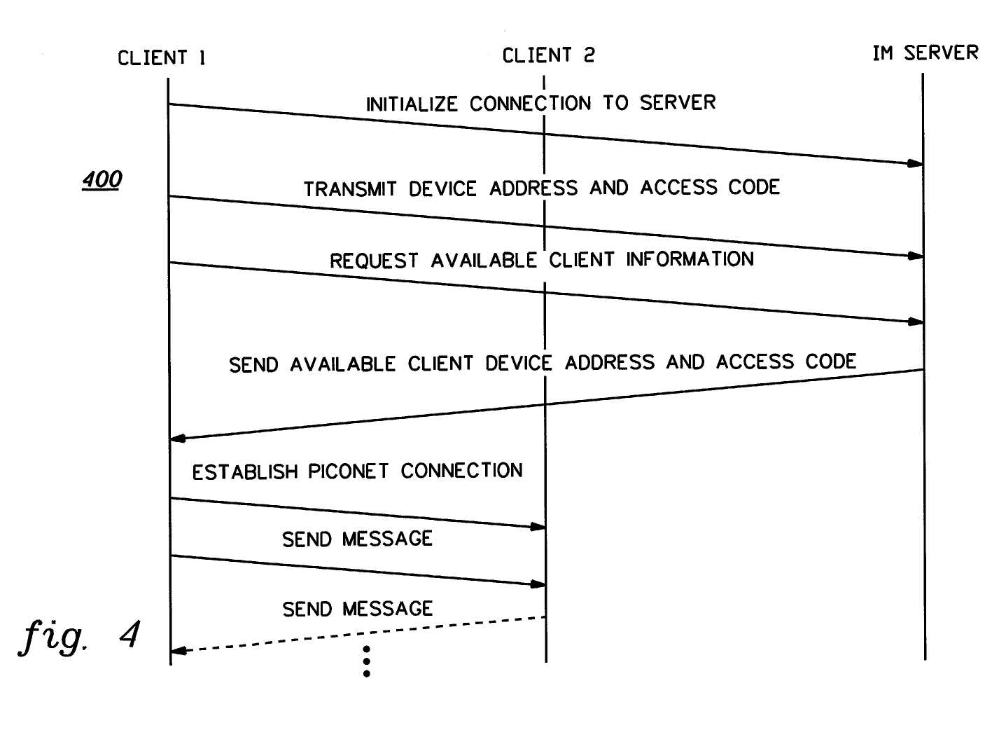

FIG. 4 depicts one example for establishing an IM session using the process of FIG. 3, wherein a wireless peer-to-peer communication is established between client1 and client2 of FIG. 1 by initially using the IM server directory. As shown in FIG. 4, the process 400 begins with client1 initializing a connection to the IM server and transmitting its device address and access code information to the server. Client1 then requests available client information from the IM server and receives device address and access code information on the available clients from the server. Thereafter, and assuming that the clients belong to the same piconet, client1 can establish a piconet connection with a desired partner client, such as client2 in order to directly send a wireless instant message communication from client1 to client2. Once the peer-to-peer connection is established, the IM communication can proceed back and forth between the wireless clients.

One embodiment for establishing a piconet connection from client1 to client2 using Jabber is presented below by way of example:

| | |
|---|---|
| SEND: | <steam:stream |

| | |
|---|---|
| SEND: | to=″client2.jabber.com″ |
| SEND: | xmlns=″jabber:client1″ |
| SEND: | xmlns=″http://etherx.jabber.com/streams″> |

| | |
|---|---|
| RECV: | <stream:stream |

| | |
|---|---|
| RECV: | xmlns=″http://ehterx.jabber.com/streams″> |
| RECV: | id=″39ABA7D2″ |
| RECV: | xmlns=″jabber:client1″ |
| RECV: | from=″client1.jabber.com″> |

Various modes of communication using the concepts of the present invention and implemented using the Jabber protocol, are presented below.

Shift from client server to peer-to-peer: This example assumes three clients are connected to a server. Two of the clients are in the same piconet, while the third client and the server are in the wired Internet. Below is an example of client1 authenticating to the server. The communication used is a TCP/IP socket initiated by the client to the server. The server accepts the network request and the following XML is exchanged from the client's point of view.

| | |
|---|---|
| SEND: | <steam:stream |

| | |
|---|---|
| SEND: | to=″server.jabber.com″ |
| SEND: | xmlns=″jabber:client″ |
| SEND: | xmlns=″http://etherx.jabber.com/streams″> |

| | |
|---|---|
| RECV: | <stream:stream |

| | |
|---|---|
| RECV: | xmlns=″http://ehterx.jabber.com/streams″> |
| RECV: | id=″39ABA7D2″ |
| RECV: | xmlns=″jabber:client″ |
| RECV: | from=″server.jabber.com″> |

| | |
|---|---|
| SEND: | <iq id=″1″ type=″set″> |

| | |
|---|---|
| SEND: | <query xmlns=jabber:iq:auth″> |

| | |
|---|---|
| SEND: | <username>user1</username> |
| SEND | <resource>r_user1</resource> |
| SEND: | <piconet_id>BD_ADDR,CAC,DAC</piconet_id> |
| SEND: | <digest>. . .</digest> |

| | |
|---|---|
| SEND: | </query> |

| | |
|---|---|
| SEND: | </iq> |

And so on. . .

This is almost the standard authentication protocol. The SEND line <piconet_id>is added to provide information on the piconet this client currently is residing in. The second client is also authenticating with the server and also provides a piconet id. The third client authenticates as well but omits the line with the piconet id information since client3 is a wired client. The server now has information about client1, client2 and client3 in its roaster, including the piconet_id for client1 and client2. The roaster thus contains the available client information discussed above.

Note that a Bluetooth access code comprises a 4 byte preamble, a 64 byte sync word and a 4 byte trailer. The channel access code is an access code that identifies a piconet. This code is included in all packets exchanged on the piconet. Using the algorithm in the Bluetooth Baseband specification, a programer can test the channel access codes to find out if they are using the same piconet.

Client/Server example: A user1 on client1 gets the roaster from the server with a list of all active clients. From that list user1 selects client3 and user3 to start an instant messaging chat with. Client1 application compares the piconet_id of client3 with its own piconet_id and finds out that the client3 does not share the same piconet. Client1 then uses the socket communication to the server to send the following XML:

| | |
|---|---|
| SEND: | <message to=″user3@client3/r_user3″type=″chat″> |

| | |
|---|---|
| SEND: | <body>This is an invitation to a client |

server chat</body>

| | |
|---|---|
| SEND: | </message> |

The server receives the stream, parses it and delivers it to client3 who will receive:

| | |
|---|---|
| RECV: | <message from=″user3@client3/r_user3″type=″chat″> |

| | |
|---|---|
| RECV: | <body>This is an invitation to a client |

server chat</body>

| | |
|---|---|
| RECV: | </message> |

Peer-To-Peer example: A user1 on client1 obtains the roaster from the server with a list of all active wireless clients. From that list user1 selects client2 and user2 to start an instant messaging chat with. The client application compares the piconet_id of client2 with its own piconet_id and finds a match. A new communication socket is established that is based on piconet communication only. Client2 accepts this network request and client1 proceeds to use the newly established socket to send the following XML:

| | |
|---|---|
| SEND: | <message to=″user3@client3/r_user3″type=″chat″> |

| | |
|---|---|
| SEND: | <body>This is an invitation to a peer-to-peer |

chat</body>

| | |
|---|---|
| SEND: | </message> |

Client2 receives the stream, parses it and displays the message to user3. The IM chat then continues over the established peer-to-peer communication path.

Those skilled in the art will understand that the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of establishing instant messaging communication between wireless devices, said method comprising:
employing an instant messaging server to identify for a first wireless device at least one additional wireless device belonging to a same piconet as the first wireless device; and
responsive to said employing, establishing direct instant messaging communication between the first wireless device and a second wireless device, wherein the second wireless device comprises one device of the at least one additional wireless device belonging to the same piconet, and wherein the direct instant messaging between the first wireless device and the second wireless device comprises direct wireless communication therebetween.

2. The method of claim 1, wherein the establishing comprises transitioning the first wireless device and the second wireless device from client/server based communication with the instant messaging server to wireless peer-to-peer communication without need for the instant messaging server therebetween.

3. The method of claim 1, wherein said employing comprises transmitting device address and access code information of the first wireless device to the instant messaging server to identify the piconet of the first wireless device, and transferring from the instant messaging server to the first wireless device available client device address and access code information to identify said at least one additional wireless device belonging to the same piconet as the first wireless device.

4. The method of claim 3, wherein said employing further comprises identifying at the first wireless device the second wireless device of said at least one additional wireless device belonging to the same piconet to which direct instant messaging communication is to be established.

5. The method of claim 3, wherein the device address and access code information transmitted by the first wireless device identifies the piconet and a user of the first wireless device, and wherein the available client device address and access code information transferred to the first wireless device identifies a piconet and a user of each wireless device of the available clients.

6. The method of claim 1, wherein said establishing comprises employing Jabber instant messaging protocol and the Bluetooth standard for wireless communication in making a direct instant messaging connection between the first wireless device and the second wireless device.

7. An instant messaging method comprising:
establishing connection of a first wireless client to an instant messaging server;
sending a request from the first wireless client to the instant messaging server for identification of available wireless clients for instant messaging;
receiving available wireless client information at the first wireless client from the instant messaging server; and
establishing direct wireless connection between the first wireless client and a second wireless client using the available wireless client information received from the instant messaging server, wherein said direct wireless connection allows direct wireless communication between the first wireless client and the second wireless client.

8. The method of claim 7, wherein the available wireless client information comprises information allowing said first wireless client to identify at least one wireless client belonging to a same piconet as the first wireless client, and wherein said direct wireless connection comprises a direct wireless piconet connection between the first wireless client and the second wireless client, wherein the second wireless client comprises one wireless client of said at least one wireless client belonging to the same piconet.

9. The method of claim 7, wherein said establishing communication between said first wireless client and said instant messaging server comprises initializing connection to the instant messaging server through an access point (AP) interface wired to the instant messaging server, wherein said first wireless client communicates by a wireless connection with the AP interface, and wherein the instant messaging server comprises a central depository connected to a wired network.

10. A system for establishing instant messaging communication between wireless devices, said system comprising:
means for employing an instant messaging server to identify for a first wireless device at least one additional wireless device belonging to a same piconet as the first wireless device; and
means for establishing direct instant messaging communication between the first wireless device and a second wireless device, wherein the second wireless device comprises one device of the at least one additional wireless device belonging to the same piconet identified by the means for employing, and wherein the direct instant messaging communication between the first wireless device and the second wireless device comprises direct wireless communication therebetween.

11. The system of claim 10, wherein the means for establishing comprises means for transitioning the first wireless device and the second wireless device from client/server based communication with the instant messaging server to wireless peer-to-peer communication without need for the instant messaging server therebetween.

12. The system of claim 10, wherein said means for employing comprises means for transmitting device address and access code information of the first wireless device to the instant messaging server to identify the piconet of the first wireless device, and means for transferring from the instant messaging server to the first wireless device available client device address and access code information to identify said at least one additional wireless device belonging to the same piconet as the first wireless device.

13. The system of claim 12, wherein said means for employing further comprises means for identifying at the first wireless device the second wireless device of said at least one additional wireless device belonging to the same piconet to which direct instant messaging communication is to be established.

14. The system of claim 12, wherein the device address and access code information transmitted by the first wireless device identifies the piconet and a user of the first wireless device, and wherein the available client device address and access code information transferred to the first wireless device identifies a piconet and a user of each wireless device of the available clients.

15. The system of claim 10, wherein said means for establishing comprises means for employing Jabber instant messaging protocol and the Bluetooth standard for wireless communication in making a direct instant messaging connection between the first wireless device and the second wireless device.

16. An instant messaging system comprising:
a first wireless device;
an instant messaging server capable of responding to the first wireless device, said instant messaging server providing identifying information to the first wireless device on at least one additional wireless device belonging to a same piconet as the first wireless device; and
wherein the first wireless device is adapted to establish direct instant messaging communication with a second wireless device, wherein the second wireless device comprises one device of the at least one additional wireless device belonging to the same piconet, and wherein the direct instant messaging communication between the first wireless device and the second wireless device comprises direct wireless communication therebetween.

17. An instant messaging system comprising:
means for establishing connection of a first wireless client to an instant messaging server;
means for sending a request from the first wireless client to the instant messaging server for identification of available wireless clients for instant messaging;
means for receiving available wireless client information at the first wireless client from the instant messaging server; and
means for establishing direct wireless connection between the first wireless client and the second wireless client using the available wireless client information received from the instant messaging server, wherein said direct wireless connection allows direct wireless communication between the first wireless client and the second wireless client.

18. The system of claim 17, wherein the available wireless client information comprises information allowing said first wireless client to identify at least one wireless client belonging to a same piconet as the first wireless client, and wherein said direct wireless connection comprises a direct wireless piconet connection between the first wireless client and the second wireless client, wherein the second wireless client comprises one wireless client of said at least one wireless client belonging to the same piconet.

19. The system of claim 17, wherein said means for establishing communication between said first wireless client and said instant messaging server comprises means for initializing connection to the instant messaging server through an access point (AP) interface wired to the instant messaging server, wherein said first wireless client communicates by a wireless connection with the AP interface, and wherein the instant messaging server comprises a central depository connected to a wired network.

20. An instant messaging system comprising:
a first wireless client adapted to establish connection to an instant messaging server;
wherein the first wireless client sends a request to the instant messaging server for information on available wireless client(s) for instant messaging;
said instant messaging server forwarding available wireless client information to the first wireless client responsive to said request; and
wherein the first wireless client establishes direct wireless connection with a second wireless client using the available wireless client information received from the instant messaging server, wherein the direct wireless connection allows direct wireless communication between the first wireless client and the second wireless client.

21. At least one program storage device readable by a machine, tangibly embodying at least one program of instructions executable by the machine to perform a method of establishing instant messaging communication between wireless devices, the method comprising:
employing an instant messaging server to identify for a first wireless device at least one additional wireless device belonging to a same piconet as the first wireless device; and
establishing direct instant messaging communication between the first wireless device and a second wireless device, wherein the second wireless device comprises one device of the at least one additional wireless device belonging to the same piconet, and wherein the direct instant messaging between the first wireless device and the second wireless device comprises direct wireless communication therebetween.

22. The at least one program storage device of claim 21, wherein the establishing comprises transitioning the first wireless device and the second wireless device from client/server based communication with the instant messaging server to wireless peer-to-peer communication without need for the instant messaging server therebetween.

23. The at least one program storage device of claim 21, wherein said employing comprises transmitting device address and access code information of the first wireless device to the instant messaging server to identify the piconet of the first wireless device, and transferring from the instant messaging server to the first wireless device available client device address and access code information to identify said at least one additional wireless device belonging to the same piconet as the first wireless device.

24. The at least one program storage device of claim 23, wherein said employing further comprises identifying at the first wireless device the second wireless device of said at least one additional wireless device belonging to the same piconet to which direct instant messaging communication is to be established.

25. The at least one program storage device of claim 23, wherein the device address and access code information transmitted by the first wireless device identifies the piconet and a user of the first wireless device, and wherein the available client device address and access code information transferred to the first wireless device identifies a piconet and a user of each wireless device of the available clients.

26. The at least one program storage device of claim 21, wherein said establishing comprises employing Jabber instant messaging protocol and the Bluetooth standard for wireless communication in making a direct instant messaging connection between the first wireless device and the second wireless device.

27. At least one program storage device readable by a machine, tangibly embodying at least one program of instructions executable by the machine to perform an instant messaging method, the method comprising:
establishing connection of a first wireless client to an instant messaging server;
sending a request from the first wireless client to the instant messaging server for identification of available wireless clients for instant messaging;
receiving available wireless client information at the first wireless client from the instant messaging server; and
establishing direct wireless connection between the first wireless client and a second wireless client using the available wireless client information received from the instant messaging server, wherein said direct wireless connection allows direct wireless communication between the first wireless client and the second wireless client.

28. The at least one program storage device of claim 27, wherein the available wireless client information comprises information allowing said first wireless client to identify at least one wireless client belonging to a same piconet as the first wireless client, and wherein said direct wireless connection comprises a direct wireless piconet connection between the first wireless client and the second wireless client, wherein the second wireless client comprises one wireless client of said at least one wireless client belonging to the same piconet.

29. The at least one program storage device of claim 27, wherein said establishing communication between said first wireless client and said instant messaging server comprises initializing connection to the instant messaging server through an access point (AP) interface wired to the instant messaging server, wherein said first wireless client communicates by a wireless connection with the AP interface, and wherein the instant messaging server comprises a central depository connected to a wired network.
